(19) United States
(12) Patent Application Publication
(10) Pub. No.: US 2010/0199345 A1
(43) Pub. Date: Aug. 5, 2010

(54) Method and System for Providing Remote Protection of Web Servers

(75) Inventor: Daniel O. Nadir, Carlsbad, CA (US)

Correspondence Address: PROCOPIO, CORY, HARGREAVES & SAVITCH LLP, 525 B STREET, SUITE 2200, SAN DIEGO, CA, 92101, US

(73) Assignee: BREACH SECURITY, INC., Carlsbad, CA (US)

(21) Appl. No.: 12/700,468

(22) Filed: Feb. 4, 2010

Related U.S. Application Data
(60) Provisional application No. 61/149,844, filed on Feb. 4, 2009.

(51) Int. Cl. G06F 21/20; G06F 21/00

(52) U.S. Cl. 726/11; 726/22

(57) ABSTRACT

Techniques for preventing attacks of web servers are provided. In one embodiment, a secure web application firewall (“WAF”) service server is provided to protect one or more web servers from malicious activity. The secure WAF service server is located at a location that is remote from the one or more web servers. Incoming traffic to the web servers and outbound traffic from the web servers is directed through the secure WAF service server. A secure WAF associated with the secure WAF service server analyzes the incoming and outbound traffic and can perform various responsive actions if malicious activity is detected.

### RELATED APPLICATIONS

This application claims the benefit of U.S. Provisional Patent Application Ser. No. 61/149,844, filed Feb. 4, 2009, entitled “METHOD AND SYSTEM FOR PROVIDING REMOTE PROTECTION OF WEB SERVERS,” which is hereby incorporated by reference in its entirety.

### FIELD OF THE INVENTION

This invention relates to computer network security, and more particularly preventing attacks on Web servers.

### BACKGROUND

Web servers attached to the Internet are vulnerable to outside attack because the nature of such servers requires them to be directly accessible from public IP addresses. For this reason, traditional firewalls are not effective because they must allow Hypertext Transfer Protocol (“HTTP”) and Hypertext Transfer Protocol Secure (“HTTPS”) traffic to reach these web servers.

More specialized protection for such web servers is available through the deployment of Web Application Firewalls (“WAFs”). A WAF can provide additional protection that is not provided by a traditional firewall. Traditional firewalls allow or deny inbound packets based on the Internet Protocol (“IP”) address or the port to which the inbound packet was addressed. In contrast, a WAF inspects both incoming and outbound packets and is able to detect and/or block suspicious or malicious activity. WAFs are traditionally deployed at the same physical location as the web servers, either out-of-line or in-line. WAFs operate in bridge mode, proxy mode, router mode and out-of-band mode.

The downside of WAF deployment is the cost and time associated with the project. A company seeking to protect its web servers must commit significant capital to acquire the hardware and/or software, and the company must plan for high availability systems, scalable management systems, and for future growth.

### SUMMARY

Techniques for preventing attacks of web servers are provided. In one embodiment, a secure WAF is provided to protect on or more web servers from malicious activity. The secure WAF is located at a location that is remote from the one or more web servers. Incoming traffic to the web servers and outbound traffic from the web servers is directed through the secure WAF. The secure WAF analyzes the incoming and outbound traffic and can take one or more responsive actions if malicious activity is detected.

According to an embodiment, a web server protection system for protecting a plurality of remote web servers is provided. The web server protection system includes a secure web application firewall service server that is coupled to a network and is located outside of firewalls associated with the each of the web servers. The secure application firewall server includes a plurality of secure web application firewalls. Each secure web application firewall is configured to receive a request from a user for content on a web server associated with the secure web application firewall that is in communication with the web server via the network, analyze the request to identify malicious activity, perform at least one responsive action if malicious activity is detected, and forward the request to the web server referenced in the request if malicious activity is not identified.

According to another embodiment, a method for protecting a plurality of web servers using a secure application firewall server located outside of the firewalls associated with each of the plurality of web servers is provided. The method includes associating a secure web application firewall of a secure web application firewall service server with each of the plurality of web servers. The requests for content on the plurality of web servers are routed to the secure web application firewall service server instead of the plurality of web servers. The method further includes receiving at the secure web application firewall service server a request for content on a web server of the plurality of web servers, analyzing the request to identify malicious activity, performing at least one responsive action if malicious activity is detected, and forwarding the request to the web server referenced in the request if malicious activity is not identified.

According to yet another embodiment, a computer-readable medium comprising processor-executable instructions that, when executed, direct a computer system to perform a set of actions is provided. The actions include associating a secure web application firewall of a secure web application firewall service server with each of the plurality of web servers. The requests for online content located on the plurality of web servers are routed to the secure web application firewall service server instead of the plurality of web servers, and the secure web application firewall service server is located outside of firewalls associated with each of the plurality of web servers. The actions further include receiving at the secure web application firewall service server a request for content on a web server from the plurality of web servers, analyzing the request to identify malicious activity, performing at least one responsive action if malicious activity is detected; and forwarding the request to the web server referenced in the request if malicious activity is not identified.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of an example system configured according to an embodiment;

FIG. 2 is a block diagram illustrating the flow of data in a traditional WAF implementation;

FIG. 3 is a block diagram illustrating the flow of data in a secure WAF implementation according to an embodiment;

FIG. 4 is a flow chart illustrating an example technique for processing inbound requests for online content according to an embodiment;

FIG. 5 is a flow chart illustrating another example technique for processing inbound requests for online content according to an embodiment;

FIG. 6 is a flow chart illustrating an example technique for processing outbound responses from a web server according to an embodiment;

FIG. 7 is a flow chart illustrating another example technique for processing outbound responses from a web server according to an embodiment;

FIG. 8 is a block diagram illustrating aspects of an example embodiment of a secure WAF system which can be carried out by the secure WAF of FIG. 1 according to an embodiment; and

FIG. 9 is a block diagram of illustrating further detail of an example dataflow in a secure WAF service as may be performed by the Web application protection module of FIG. 1.

### DETAILED DESCRIPTION

The following detailed description is directed to certain specific embodiments of the invention. However, the invention can be embodied in a multitude of different systems and methods. In this description, reference is made to the drawings wherein like parts are designated with like numerals throughout.

Systems and methods are provided for providing a secure WAF service system. The secure WAF service system is located at a location that is remote from one or more web servers protected by the WAF services. Unlike a traditional WAF, where customers must make a large investment to purchase, install, and maintain complex and expensive hardware, the secure WAF service system installed and maintained at a remote location and the WAF protections services are offered to customers.

Inbound and outbound web traffic to a customers' web server is routed through the secure WAF service system in order to identify malicious behavior (also referred to herein as “malicious activity”). The WAF service model can dramatically lower the cost of protecting a web server, because the customer is not required to purchase, install, or maintain WAF hardware. Additional benefits, protections and variations over traditional WAF deployments can also be achieved.

The secure WAF service server can comprise one or more secure WAF modules provisioned at remote off-site location, such as a secure data center. The secure WAF modules are highly available, highly scalable, and provide high performance processing of incoming and outbound traffic for customer's web servers. Web requests (traffic from web users intended for the web servers being protected) are then redirected or routed through the secure WAF service then to the destination web server for processing, then back through the secure WAF service to the web user who sees the result of his request. In one embodiment this redirection is implemented when the company's Domain Name System (“DNS”) record(s) are modified to point to the secure WAF service instead of the web servers themselves and the company's firewall rules are modified to allow web traffic from only the Secure WAF Service. The secure WAF tracks the incoming IP address and routes the outgoing packet to the corresponding web server after processing.

As described above, the secure WAF service server 128 can include one or more secure web application firewall (WAF) modules 129. In an embodiment, each secure WAF module 129 is configured to protect a particular web server, while in another embodiment a secure WAF can be configured to protect one or more web servers. In an embodiment, the number of web servers protected by a single secure WAF 129 may be based in part on the amount of web traffic to and from a particular web server. The greater the amount of inbound and outbound traffic from a particular web site, the greater the amount of computer resources (e.g., memory and processor usage) that will be required to process the traffic.

According to an embodiment, each secure WAF 129 can be implemented in hardware and/or software. For example, in some embodiments, the secure WAF service system can include multiple computer systems that each implements a secure WAF 129 that provides protection to one or more web servers. For example, the secure WAFs 129 may be implemented as a rack-mounted computer systems in a secure data center. According to an alternative embodiment, one or more secure WAFs 129 may be implemented as software instances on a computer system, such as a rack-mounted computer system. Each software instance of a secure WAF 129 can be configured to support one or more web servers. The number of software instances implemented on a single computer system may be limited by computer resources such as memory and processor resources. Therefore, in some embodiments, the secure WAF 129 service system may include multiple computer systems that each support one or more software instances of secure WAFs 129.

According to some embodiments, the secure WAF service server 128 is assigned a single network address, and inbound and/or outbound traffic for each of the web servers that the secure WAF service system is configured to protect is routed through the secure WAF service server 128. The secure WAF service server 128 examines requests to determine which web server the request was intended to reach and routes the requests to the secure WAF 129 that is configured to process requests for that web server. The secure WAF service server 128 can identify the secure WAF 129 that is configured to process outbound traffic for a particular web server based on the network address of the web server from which the outbound traffic is received.

According to some embodiments, the secure WAF service server 128 can be associated with multiple network addresses and each secure WAF 129 can be associated with a different network address. The secure WAF service server 128 can then map requests associated with a particular web server to the secure WAF 129 that is configured to process inbound and/or outbound traffic associated with the secure WAF 129.

Embodiments of the secure WAF can be used to prevent various types of malicious activity/malicious behavior, such as preventing attacks targeting web servers and web applications running on web servers including SQL injection attacks, session hijacking, excessive access rate attacks, and/or other types of malicious behavior. SQL injection attacks exploit security vulnerabilities in the database layer of web applications by fooling an application into accepting a string from the user that includes both data and database commands where a string containing just data is expected. Session hijacking attacks focus on weaknesses in the implementation of session mechanisms used in web applications. Attackers can manipulate these mechanisms to impersonate legitimate users in order to access sensitive account information and functionality. Excessive access rate attacks deluge a web site or web server with a large number of requests in a short period of time in order to negatively impact the performance of the Web site. Techniques for preventing SQL injection and session hijacking attacks are described in related U.S. patent application Ser. No. 11/532,060, which is herein incorporated by reference in its entirety, and techniques for detecting and blocking excessive access rate attacks are described below. According to an embodiment, the Web application protection system can detect and prevent multiple types of attacks simultaneously.

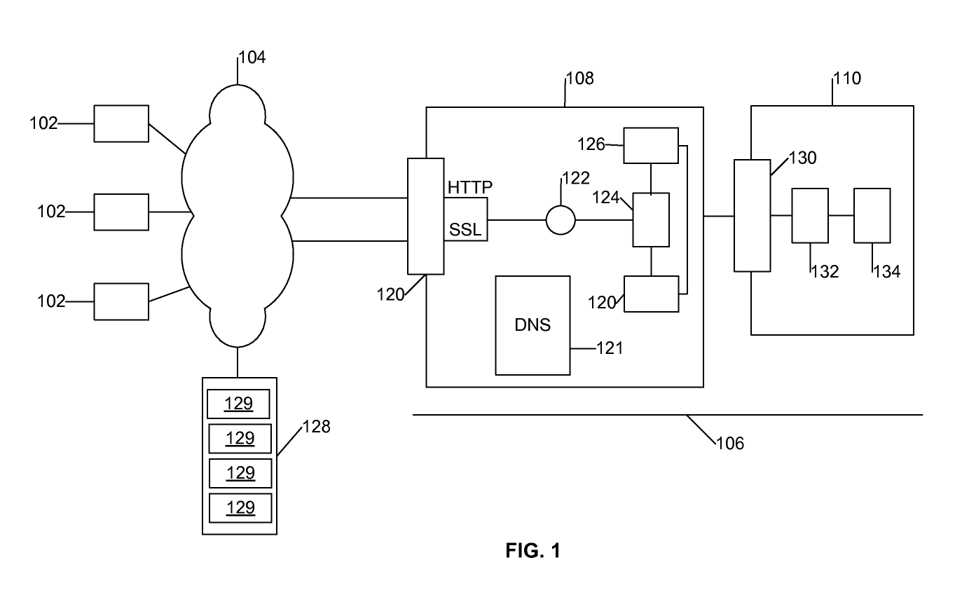

FIG. 1 is a block diagram of an example system configured in accordance with aspects of the invention. The example system includes a secure WAF service server 128 (also referred to herein as “the protection system”). The secure WAF service server 128 provides secure WAF services to web servers 126.

As shown in FIG. 1 users 102 are in communication with a wide area network 104. The wide area network 104 may be a private network, a public network, a wired network, a wireless network, or any combination of the above, including the Internet. Also in communication is a computer network 106. A typical computer network 106 may include two network portions, a so called demilitarized zone (DMZ) 108, and a second infrastructure network 110. The DMZ 108 is usually located between the wide area network 104 and the infrastructure network 110 to provide additional protection to information and data contained in the infrastructure network 110.

For example, the infrastructure network 110 may include confidential and private information about a corporation, and the corporation wants to ensure that the security and integrity of this information is maintained. However, the corporation may host a web site and may also desire to interface with users 102 of the wide area network 104. For example, the corporation may be engaged in e-commerce and wants to use the wide area network 104 to distribute information about products that are available to customers, and receive orders from customers. The interface to the wide area network 104, which is generally more susceptible to attacks from cyber-criminals is through the DMZ 108, while sensitive data, such as customer credit card information and the like, are maintained in the infrastructure network 110 which is buffered from the wide area network 104 by the DMZ 108.

Examples of components in a DMZ 108 include a firewall 120 that interfaces the DMZ 108 to the wide area network 104. Data transmitted and received from the wide area network 104 pass through the firewall 120, through a mirror port 122 to a load balancer 124 that controls the flow of traffic to web servers 126.

Also shown is a domain name server (DNS) 121. However, DNS 121 may be located outside of the network 106. One function of the DNS 121 is to respond to DNS queries by providing the IP address associated with a domain name. The DNS 121 would typically have a directory table loaded into its memory which correlates domain names to IP addresses.

In one embodiment, the directory table of the DNS 121 is altered to replace the IP address associated with the domain name of the web server(s) with an IP address of the secure WAF service server 128 so that requests from users 102 for content on the web servers 126 will be routed to secure WAF service server 128. In an embodiment, outbound traffic from the web servers 126 to the users is also routed through the secure WAF service server 128 in order to analyze both the inbound and outbound traffic to identify malicious activity/malicious behavior.

In an embodiment, the firewall 120 is configured to only accept inbound traffic for the web server 126 that has been received from the secure WAF service server 128. This ensures that the secure WAF service server 128 is able to monitor and analyze all inbound traffic that is send to the web servers 126 in order to identify and take responsive actions against malicious behavior.

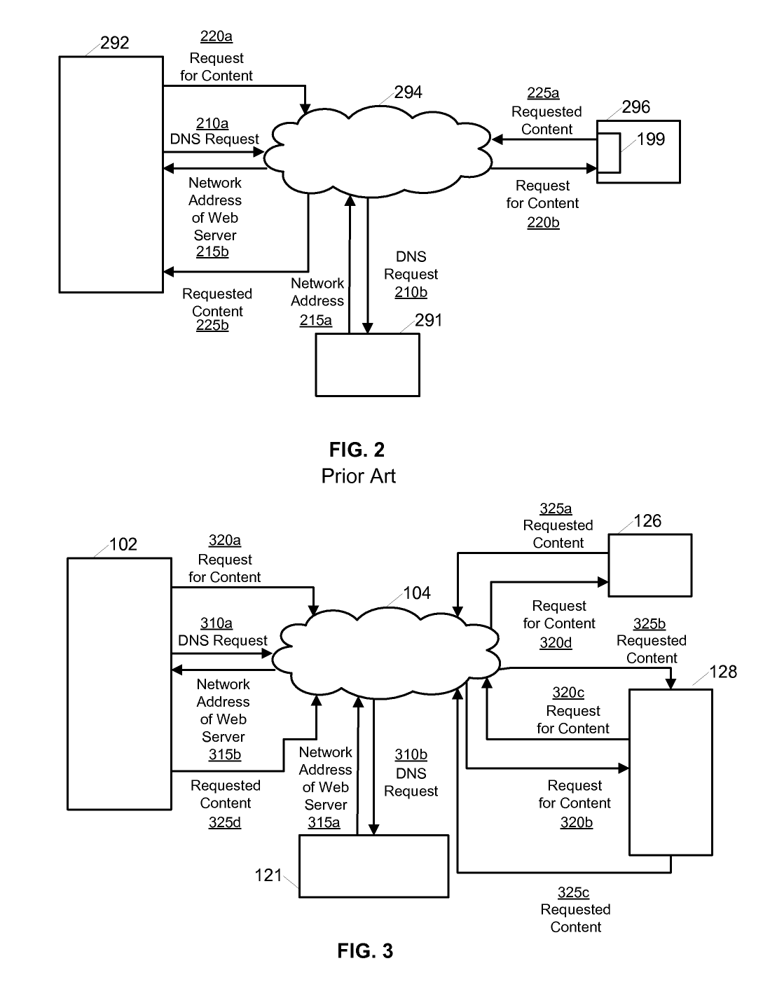

FIG. 2 is a block diagram illustrating the flow of data in a traditional WAF protection module where the WAF 199 is installed at the location of a web server 926. In the traditional model illustrated in FIG. 2, a user of computer system 292 requests online content. For example, the user may enter a website address into a web browser program running on the computer system 292. The computer system 292 makes a DNS query 210a which is transmitted to a DNS server 291 via wide area network 294. The wide area network 294 may be a private network, a public network, a wired network, a wireless network, 926 or any combination of the above, including the Internet. The DNS server 291 receives the DNS query 210b from the wide area network 294 and processes the query to resolve the network address for the web server 296 from the domain name that the user entered into the browser on computer system 292. According to an embodiment, the IP address of the web server 296 is determined by the DNS server by looking up the domain name entered by the user in a DNS table that provides a mapping between domain names and IP addresses. Alternatively, the DNS table can include the IP address of a proxy server (not shown) that acts as an intermediary for the web server 296.

The DNS server 291 sends the network address 215a of the web server 296 to computer system 292 via network 294. The computer system 292 receives the network address 215b from the network 294 and uses the network address to send a request for online content 220a to web server 296 via network 104.

The web server 296 receives the requested for content 220b from the network 294 and the WAF 199 located at the web server 326 monitors the request in order to identify malicious activity.

The web server 296 provides the requested content 225a to the computer system 292 via computer network 294. The requested content 220a is monitored by the WAF 199. The computer system 292 receives the requested content 225b from the network 104. WAF 199 monitors and/or processes the incoming traffic to the web server 296 and any outbound traffic from web server 296. If any malicious behavior is identified, various actions may be taken, including blocking incoming and/or outgoing traffic.

FIG. 3 is a block diagram illustrating the flow of data in a system where a secure WAF service server 128 is used to protect a web server 126 according to an embodiment. In the embodiment illustrated in FIG. 3, the secure WAF service server 128 comprises a single secure WAF 129 in order to more clearly illustrate the flow of data. However, the secure WAF service server 128 can be configured to include multiple secure WAFs 129 implemented in software and/or hardware as described above.

In the secure WAF model illustrated in FIG. 3, a user of computer system 102 requests online content. For example, the user may enter a website address into a web browser program running on the computer system 102. The computer system 102 makes a DNS query 310a which is transmitted to a DNS server 121 via wide area network 104. The wide area network 294 may be a private network, a public network, a wired network, a wireless network, 926 or any combination of the above, including the Internet. The DNS server 291 receives the DNS query 210b from the wide area network 294 and processes the query to resolve the network address associated with the domain name that the user entered into the browser on computer system 292. According to an embodiment, the IP address of the secure WAF service server 128 is associated with the domain name of the web site in the DNS table so that requests for online content are directed to the WAF server 128 for processing rather than to the web server 126 directly for processing. According to an embodiment, the secure WAF service server 128 either makes a copy of the web traffic for out-of-line processing, or the secure WAF service server 128 operates in bridge, router or proxy mode and processes packets in-line. The secure WAF service server 128 immediately forwards this web traffic to the protected corporate web server ensuring virtually zero latency and waits for the reply, which the secure WAF service server 128 can then forward to the web user of computer system 102. According to an alternative embodiment, the secure WAF service server 128 receives the incoming request, selects an appropriate secure WAF 129 for processing the request, and the secure WAF 129 processes the request including forwarding any copies of the request to the web server.

The DNS server 121 sends the network address 215a of the secure WAF service server 128 to computer system 292 via network 104. The computer system 102 receives the network address 315b from the network 294 and uses the network address to send a request for online content 220a to secure WAF service server 128 via network 104.

The secure WAF service server 128 receives the request for online content 320b from network 104 and provides the request to the secure WAF 129 for processing in order to identify potentially malicious activity. If malicious activity is detected, the secure WAF 129 and/or the secure WAF service server 128 may take one more responsive actions. Otherwise, if no malicious activity is detected by secure WAF 129, the request for online content 320c is forwarded to the web server 126.

The web server 126 receives the requested for content 320d from the network 104 and provides the requested content 225a to the secure WAF service server 128 via computer network 104. The secure WAF service server 128 receives the requested content 225b from the network 104. The secure WAF service server 128 monitors and/or processes the incoming traffic to the web server 126 and any outbound traffic from web server 296. If any malicious activity/malicious behavior is identified, various actions may be taken, including blocking incoming and/or outgoing traffic.

The WAF server 128 forwards the requested content 325c to the computer system 102 via network 104 if no malicious activity/malicious behavior is identified. Computer system 102 receives the requested content 325d from the network.

The use of secure WAF services enables companies of any size to have the same level of protection that only the largest corporations can usually afford: very high end computing platforms, high availability, and enterprise management, all without any large capital expenditures and without any hardware deployment or hardware configuration required on-site with the web server 126. Furthermore, customers using a secure WAF service can lock in a price for an extended period and be guaranteed that the customers will not be faced with the need to replace obsolete equipment should their requirements or traffic volumes change dramatically.

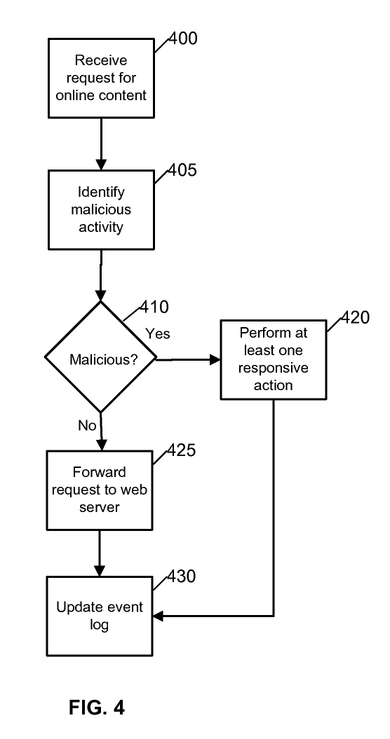

FIG. 4 is a flow chart illustrating an example technique for processing inbound requests for online content according to an embodiment. In the embodiment illustrated in FIG. 4 the secure WAF service server 128 provides in-line processing of inbound and outbound traffic where secure WAF service server 128 processes the inbound and outbound traffic to identify malicious activity/malicious behavior before forwarding incoming requests to the web server 126 or outbound online content to the client computer system 102. The method illustrated in FIG. 4 can be implemented in secure WAF service server 128 in software modules stored in a computer-readable medium and executed by a computer processor, can be implemented in hardware, or a combination thereof.

The secure WAF service server 128 receives a request for online content from a user's computer system 102 (step 400). As described above, the user may enter a web address for a web server (e.g., “www.somesite.com”) into web browser software running on the user's computer system 102 and the user's computer system 102 sends a DNS lookup to DNS server 121 to resolve the network address DNS server 121 associated with the web address. In the present embodiment, the DNS tables used by the DNS server 121 associates the network address of secure WAF 128 rather than the network address of the web server 126. Any inbound requests are routed to the secure WAF service server 128 for processing rather than being routed directly to the web server 126.

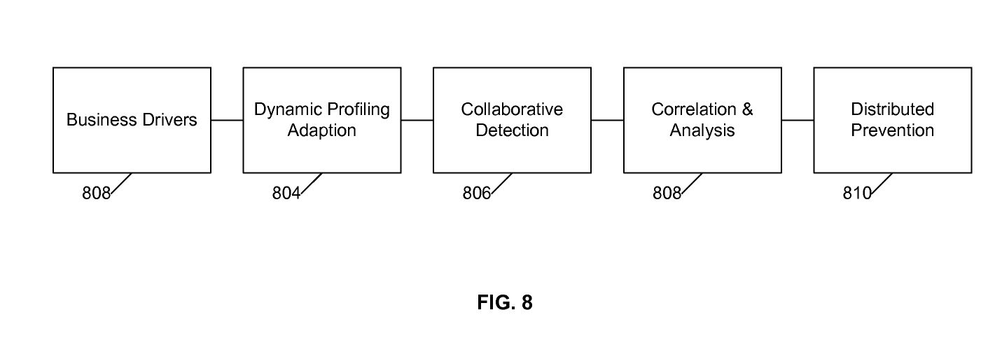

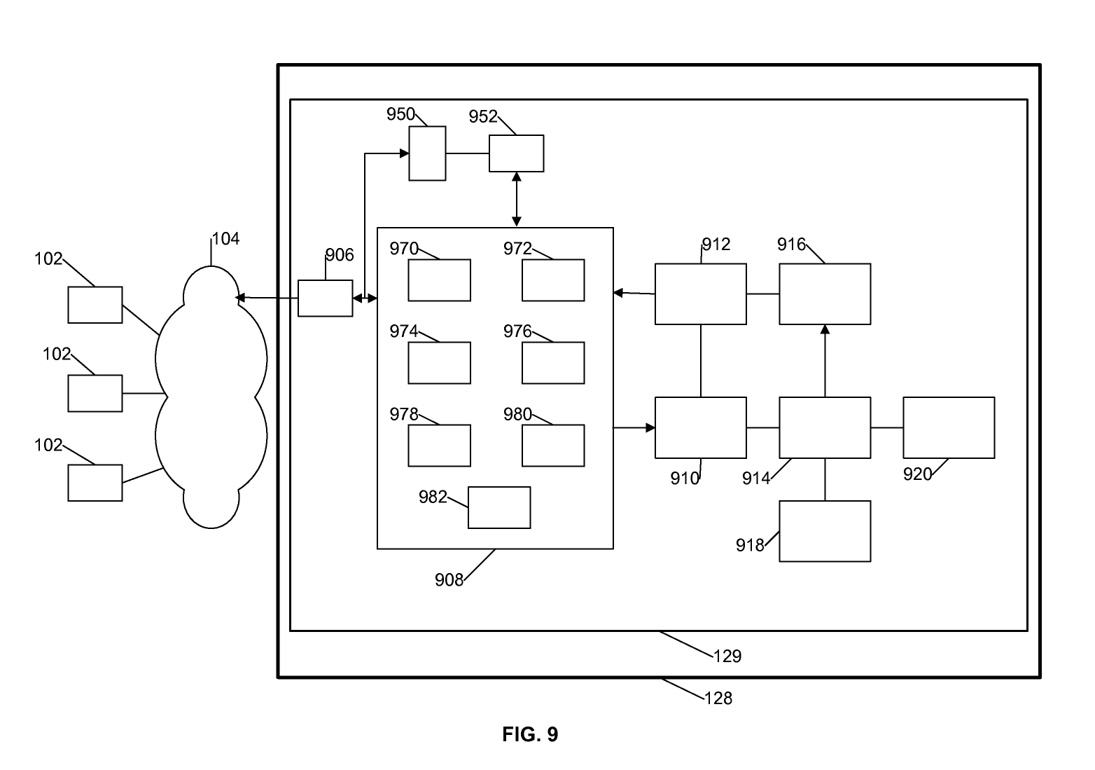

The secure WAF service server 128 then provides the request to the secure WAF associated with the web server to which the request is directed, and the secure WAF 129 processes the request to identify malicious activity (step 405). The secure WAF 129 makes a determination whether any malicious activity was identified (step 410). If malicious activity was identified, at least one responsive action is performed (step 420). Examples of the types of responsive actions that can be taken are described below with reference to FIGS. 8 and 9. An event log associated with the secure WAF 129 and/or the secure WAF service server 128 is updated to include information identifying the malicious activity that occurred (step 430). If no malicious activity was identified by the secure WAF 129, the request for online content is forwarded to the web server for processing (step 425). The event log associated with the secure WAF 129 and/or the secure WAF service server 128 can then be optionally updated to include information related to the request that was forwarded to the web server 126 (step 430).

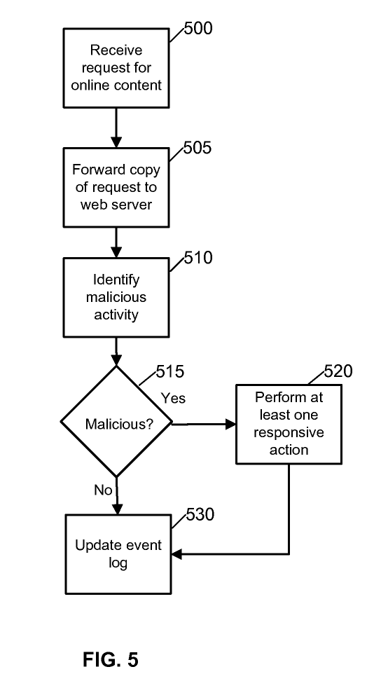

FIG. 5 is a flow chart illustrating another example technique for processing inbound requests for online content according to an embodiment. In the embodiment illustrated in FIG. 5, the secure WAF service server 128 provides out-of-line processing of requests for online content where requests received by the secure WAF service server 128 are immediately forwarded to the web server 126 for processing and then secure WAF service server 128 processes the request to identify malicious activity/malicious behavior. In an embodiment, the method illustrated FIG. 5 is be implemented in secure WAF service server 128 in software modules stored in a computer-readable medium and executed by a computer processor, can be implemented in hardware, or a combination thereof.

The secure WAF service server 128 receives a request for online content from a user's computer system 102 (step 500). In contrast to the method described in FIG. 4, a copy of the request is forwarded to the web server 136 for processing (step 505) before the request has been processed by a secure WAF 129 of the secure web service server 128 to identify malicious activity. According to some embodiments, the secure WAF service server 128 forwards a copy of the request to the web server 136 before providing a copy of the request to the secure WAF 129. According to another embodiment, the secure WAF service server 128 provides a copy of the request to the secure WAF 129 associated with the web server 136, and the secure WAF 136 forwards a copy of the request to the web server 136 before processing the request. According to some embodiments, each secure WAF may be separately configured to perform in-line or out-of-line processing on request. In an embodiment, a secure WAF may be configured to perform in-line or out-of-line processing on a web server by web server basis. The secure WAF service server 128 can include an administrator user interface that allows an administrator to configure the operating parameters of each secure WAF.

After a copy of the request is forwarded to the web server 136, the secure WAF 129 processes the request to identify malicious activity (step 510). The secure WAF 129 makes a determination whether any malicious activity was identified (step 515). If malicious activity was identified, at least one responsive action is performed by the secure WAF 129 and/or the secure WAF service server 128 (step 420). Examples of the types of responsive actions that can be taken are described below with reference to FIGS. 8 and 9. An event log associated with the secure WAF 129 and/or the secure WAF service server 128 is updated to include information identifying the malicious activity that occurred (step 530). If no malicious activity was identified, the event log associated with the secure WAF 129 and/or the secure WAF service server 128 can then be optionally updated to include information related to the request that was forwarded to the web server 126 (step 530).

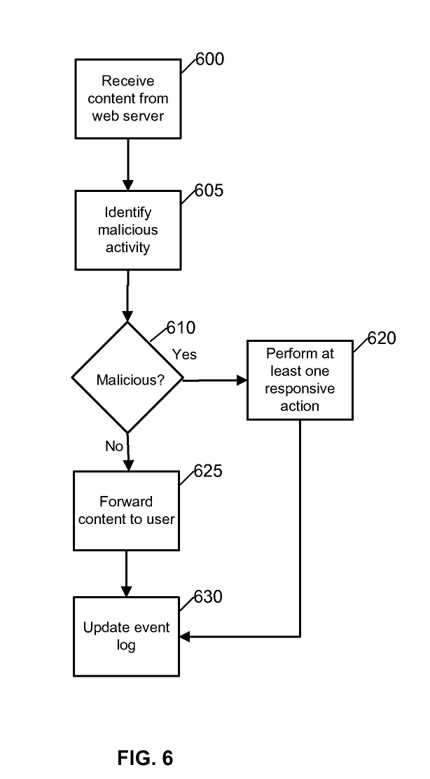

FIG. 6 is a flow chart illustrating another example technique for processing outbound responses from a customer's web server according to an embodiment. In the embodiment illustrated in FIG. 6 the secure WAF service server 128 provides in-line processing of inbound and outbound traffic. The method illustrated FIG. 6 can be implemented in secure WAF service server 128 in software modules stored in a computer-readable medium and executed by a computer processor, can be implemented in hardware, or a combination thereof.

The secure WAF service server 128 receives requested web content from web server 126 (step 600). The secure WAF service server 128 identifies the secure WAF 129 associated with the web server, and provides the received content to the secure WAF 129 for processing to identify malicious activity (step 605). The secure WAF 129 makes a determination whether any malicious activity was identified (step 610). If malicious activity was identified by the secure WAF 129, the secure WAF 129 associated with the web server and/or the secure WAF service server 128 performs at least one responsive action (step 620). Examples of the types of responsive actions that can be taken are described below with reference to FIGS. 8 and 9. An event log associated with the secure WAF 129 and/or the secure WAF service server 128 can also be updated to include information identifying the malicious activity that occurred (step 630).

If no malicious activity was identified, the requested online content received from the web server 136 is forwarded to the user's computer system 102 (step 625). The event log associated with the secure WAF 129 and/or the secure WAF service server 128 can then be optionally updated to include information related to the request and/or the response received from the web server 126 (step 630).

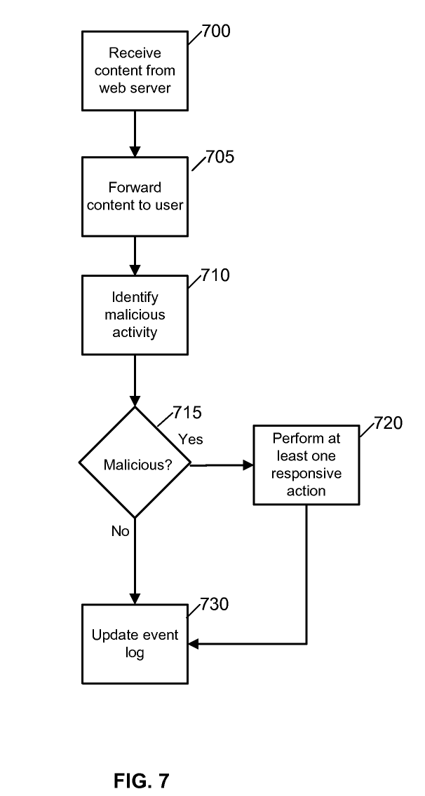

FIG. 7 is a flow chart illustrating another example technique for processing outbound responses from a customer's web server according to an embodiment. In the embodiment illustrated in FIG. 7, the secure WAF service server 128 provides out-of-line processing inbound traffic received by the secure WAF service server 128 is forwarded to the web server 126 before being processed by the secure WAF service server 128 to identify malicious activity/malicious behavior and outbound traffic received by the secure WAF service server 128 from the web server 136 is forwarded to the client's computer system 102 before the outbound content is processed by the secure WAF service server 128 to identify malicious behavior. In an embodiment, the method illustrated FIG. 7 is be implemented in secure WAF service server 128 in software modules stored in a computer-readable medium and executed by a computer processor, can be implemented in hardware, or a combination thereof.

The secure WAF service server 128 receives requested web content from web server 126 (step 700). According to some embodiments, the secure WAF service server 128 forwards a copy of the received content before providing a copy of the content to the secure WAF 129 for processing. According to another embodiment, the secure WAF service server 128 provides a copy of the content to the secure WAF 129 associated with the web server 136, and the secure WAF 136 forwards a copy of the content to the user 102 before processing the content. According to some embodiments, each secure WAF may be separately configured to perform in-line or out-of-line processing on request. In an embodiment, a secure WAF may be configured to perform in-line or out-of-line processing on a web server by web server basis. As described above, the secure WAF service server 128 can include an administrator user interface that allows an administrator to configure the operating parameters of each secure WAF.

The requested online content received from the web server 136 is forwarded to the user's computer system 102 (step 705). The secure WAF 129 of the secure WAF service server 128 then processes the received content to identify malicious activity (step 710). The secure WAF 129 makes a determination whether any malicious activity was identified (step 710). If malicious activity was identified by the secure WAF service server 128, the secure WAF service server 128 performs at least one responsive action (step 720). Examples of the types of responsive actions that can be taken are described below with reference to FIGS. 8 and 9. An event log associated with the secure WAF 129 and/or the secure WAF service server 128 can also be updated to include information identifying the malicious activity that occurred (step 730).

If no malicious activity was identified, the event log associated with the secure WAF 129 and/or the secure WAF service server 128 can then be optionally updated to include information related to the request and/or the response received from the web server 126 (step 730).

Exemplary Embodiments of Secure Web Application Firewall

Exemplary implementations of a secure WAF service server are provided in FIGS. 8 and 9. In these embodiments, various unique security challenges inherent to protecting web servers and web based applications are addressed. The exemplary embodiments employ a technique that includes combining a behavioral protection model with a set of collaborative detections modules that includes multiple threat detection engines to provide security analysis within the specific context of the web application. In addition, the techniques reduce the manual overhead encountered in configuring a behavioral model, based upon a profile of typical or appropriate interaction with the application by a user, by automating the process of creating and updating this profile. Further, the techniques include a robust management console for ease of setup and management of Web application security. The management console allows security professionals to setup an application profile, analyze events, and tune protective measures. In addition, the management console can provide security reports for management, security professionals and application developers.

Because web application attacks are typically targeted, and may require reconnaissance, the techniques are adapted to block attacks from a hacker, or cyber-criminal, before they are able to gather enough information to launch a successful targeted attack. Various techniques may be combined, or associated, to be able to identify and correlate events that show an attacker is researching the site, thereby giving organizations the power to see and block sophisticated targeted attacks on the application.

Some of the advantages provided by the techniques described include protecting privileged information, data, trade secrets, and other intellectual property. The techniques fill gaps in network security that were not designed to prevent targeted application level attacks. In addition, the techniques dynamically generate, and automatically maintain, application profiles tailored to each Web application. The techniques can also provide passive SSL decryption from threat analysis without terminating an SSL session.

Additional protection of customer data is provided by exit control techniques that detect information leakage. A graphical user interface (GUI) can provide detailed event analysis results as well as provide detailed and summary level reports that may be used for compliance and audit reports. Use of various combinations of these techniques can provide comprehensive protection against known, as well as unknown, web threats.

FIG. 8 is a block diagram illustrating aspects of an example embodiment of a secure WAF service which can be carried out by the secure WAF service server 128 in FIG. 1. As shown in FIG. 8, a business driver module 802 provides input about the types of threats that are anticipated, and that protection against which is sought, or the types of audits or regulations that an entity wants to comply with. Examples of threats include identity theft, information leakage, corporate embarrassment, and others. Regulatory compliance can include SOX, HIPAA, Basel LL, GLBA, and industry standards can include PCI/CISP, OWASP, and others. The business driver module 202 provides input to a dynamic profiling module 804.

The dynamic profiling module 804 develops profiles of web applications. The profiles can take into account the business drivers. The profiles can also be adapted as Web applications are used and user's behavior is monitored so that abnormal behavior may be identified. The profiles can also be adapted to identify what types of user input is considered appropriate, or acceptable. Dynamic profiling module 204 provides input to a collaborative detection module 806.

The collaborative detection module 806 uses the input from the dynamic profiling module 204 to detect attacks against a web application. The collaborative detection module can monitor, and model, a user's behavior to identify abnormal behavior of a user accessing a web application. The collaborative detection module 806 can also monitor user activity to identify signatures of attack patterns for known vulnerabilities in a web application. Other aspects include protection against protocol violations, session manipulation, usage analysis to determine if a site is being examined by a potential attacker, monitoring out bound traffic, or exit control, as well as other types of attack such as XML virus, parameter tampering, data theft, and denial of services attacks. The collaborative detection module 806 provides the results of its detection to a correlation and analysis module 808.

The correlation and analysis module 808 receives the detection results from the collaborative detection module 806 and performs event analysis. The correlation and analysis module 808 analyses events reported by the collaborative detection module 206 to determine if an attack is taking place. The correlation and analysis module 808 can also correlate incoming requests from users with outgoing response to detect if there is application defacement or malicious content modification being performed. The correlation and analysis module may establish a severity level of an attack based upon a combined severity of individual detections. For example, if there is some abnormal behavior and some protocol violations, each of which by itself may set a low severity level, the combination may raise the severity level indicating that there is an increased possibility of an attack. The output of the correlation and analysis module 808 is provided to a distributed prevention module 810.

The distributed prevention module 810 provides a sliding scale of responsive actions depending on the type and severity of attack. Examples of responses by the distribution prevention module 810 include monitor only, TCP-resets, load-balancer, session-blocking, firewall IP blocking, logging users out, and full blocking with a web server agent. The distribution prevention module 810 can also include alert mechanisms that provide event information to network and security management systems through SNMP and syslog, as well an email and console alerts.

Using the dynamic profiling module 804, collaborative detection module 806, correlation and analysis module 808, and distributed prevention module 810 security for a Web application can be provided. Improved Web application security provides protection of privileged information, increased customer trust and confidence, audit compliance, increased business integrity, and brand production.

FIG. 9 is a block diagram of illustrating further detail of an example dataflow in a web application security technique as may be performed by the secure WAF service server 128 of FIG. 1. The secure WAF service server 128 illustrated in FIG. 9 includes single secure WAF 129 that includes a number of modules for processing incoming and outbound traffic from one or more web servers in order to detect malicious activity and perform one or more responsive actions if malicious activity is detected.

In some embodiments, the secure WAF service server 128 may include multiple secure WAFs 129. According to some embodiments, the multiple secure WAFs 129 can be implemented on multiple computer systems that each implements the modules illustrated in FIG. 9. In some embodiments, each secure WAF 129 can be implemented as a separate computer system, such as a rack computer system in a secure data center, while in other embodiments, multiple instances of a secure WAF 129 may be implemented on the same computer system. According to some embodiments, a secure WAF 129 may be configured to process inbound and outbound traffic for a single web server, while in other embodiments, a secure WAF 129 may be configured to process inbound and outbound traffic for multiple web servers. In embodiments where a secure WAF 129 is used to process inbound and outbound traffic for

In embodiments of the secure WAF service server 128 that include multiple secure WAFs 129, the secure WAF service server 128 can use information from the request and/or response from web server to determine which secure WAF 129 should be selected to process the inbound or outbound traffic. For example, the DNS entries associated with multiple web servers may be associated with the network address of the secure WAF service server 128 causing requests for each of these web servers to be routed to the secure WAF service server 128. The secure WAF 129 can examine the contents of the request to determine which secure WAF 129 should process the request. For example, if the request is an HTTP request, the contents of the header of the request can be examined to determine the host name of the web server for which the request was intended. The secure WAF service server 128 can maintain a mapping for each secure WAF 129 that identifies which web servers are associated with the secure WAF 129 and route traffic to the appropriate secure WAF 129 for processing.

According to an alternative embodiment, the secure WAF service server 128 may have multiple network addresses associated with the secure WAF service server 128 such that traffic send to any of these network addresses is routed to the secure WAF service server 128. Each secure WAF 129 may then be associated with a different network address, and the secure WAF service server 128 can route received traffic to the correct secure WAF for processing based on the network address to which the traffic was routed.

As illustrated in FIG. 9 multiple users 102 are in communication with a wide area network 104, such as the Internet. The users may desire to access a Web application. Typically, a user will access a Web application with web traffic using SSL encryption. A SSL decryption module 906 can passively decrypt the traffic to allow visibility into any embedded threats in the web traffic. The web traffic then flows to a collaborative detection module 908 where the traffic is analyzed in the context of appropriate application behavior compared to the applications' security profile. If an anomaly is discovered, it is passed to one or more of the multiple threat-detection engines included within the collaborative detection module 908. The results from the collaborative detection module 908 are communicated to an Advanced Correlation Engine (ACE) 910 where it is determined the threat context and to reduce false positives. In addition, the collaborative detection module 908 monitors outbound traffic as well as inbound traffic to prevent data leakage such as Identity Theft.

According to an embodiment, the secure WAFs of the secure WAF service server 128 can collaborate to identify malicious behavior. If a secure WAF identifies malicious behavior or activity, the secure WAF can share the parameters of the malicious activity or behavior with other secure WAFs of the secure WAF service server 128 to enable the other secure WAFs to identify and respond to similar behavior.

Collaborative Detection Module

The following discussion provides additional detail of the collaborative detection module 908 illustrated in FIG. 9. As noted in the discussion of FIG. 9 web traffic flows to the collaborative detection module 908 where the traffic is analyzed. The traffic is analyzed by a behavior analysis engine 970 in the context of appropriate application behavior compared to the applications' security profile. If an anomaly is discovered the traffic is passed to one or more of the multiple threat-detection engines included within the collaborative detection module 908. The multiple threat-detection engines work synergistically to deliver comprehensive web application protection that spans a broad range of potentially vulnerable areas. By working together the multiple threat-detection engines are able to uncover threats by analyzing them in the context of the acceptable application behavior, known web attack vectors and other targeted web application reconnaissance.

Behavioral Analysis Engine

The behavioral analysis engine 970 provides positive validation of all application traffic against a profile of acceptable behavior. A security profile of acceptable application behavior is created and maintained by the adaption module 950 which monitors Web traffic and continually updates and tunes a security profile module 952 that maintains the security profiles of applications. A security profile of an application maps all levels of application behavior including HTTP protocol usage, all URL requests and corresponding responses, session management, and input validation parameters for every point of user interaction. All anomalous traffic identified by the behavioral analysis engine 970 is passed to one or more threat detection engines to identify any attacks and provide responsive actions. This ensures protection from all known and unknown attacks against Web applications.

Signature Analysis Engine

One threat detection engine in the collaborative detection module 908 can be a signature analysis engine 972. The signature analysis engine 972 provides a database of attack patterns, or signatures, for known vulnerabilities in various web applications. These signatures identify known attacks that are launched against a web application or any of its components. Signature analysis provides a security context for the anomalies detected by the behavioral analysis engine 970. When attacks are identified they can be ranked by severity and can be responded to with preventative actions. This aspect of the Web application security system provides protection from known attacks against Web applications, Web servers, application servers, middleware components and scripts, and the like.

A signature is a combination of terms and conditions, that when fully met define a security issue or other meaningful event (e.g. server technology). Examples of main terms and conditions include patterns and their way of appearance in different contexts of the request/reply. For example, matching a request-reply pair for a specific signature is one technique of specifying that terms and conditions defining a signature where met by a request-reply pair.

Signatures may also be based on matching predetermined patterns against data, at specified locations, in the request-reply pair. For example, matching a pattern for “onclick” against request content. The patterns can be either a simple pattern (i.e. a string) or a regular expression. In general, pattern matching technology may be less efficient when matching regular expression as opposed to matching simple patterns. Therefore, it is usually preferred to use simple pattern over regular expression.

Following are examples of locations within the request-reply pair where signature patterns can be matched against: (1) URL, (2) a normalized URL; (3) parameters value; (4) request normalized parameters names; (5) request normalized parameters values; (6) request headers values; (7) request headers names; (8) request specific header (with provided name); (9) request content; (10) reply content; (11) reply HTML title; and (12) cookies (OTB).

In one embodiment, a signature can be composed of matching one or more patterns with various relations. For example, a relation may be that all patterns should appear, X out of Y patterns should appear, a distance between patterns should be Z, etc.

Search technologies can include: (1) Simple patterns match—pattern/s that appear in the requested location. Each pattern is configured with a separate location. No special relations between the patterns are required; (2) Complex Pattern—search Complex Pattern is a sequence of patterns with relations of words skip or characters skip between them. One example of word skip is to search for patterns that appear with the specified number of words between them. An example search would be for a pattern of “SQL” and “error” with a work skip equal to 1.

In the example the string “SQL syntax error” matches the search, while the string “SQL error” does not match. Search patterns can also be setup where the number of words between search terms can be up to a desired number. For example, a search can be for “SQL” and “error” with a word skip value of “up to 1.” In this case both the string “SQL syntax error” and the string “SQL error” match this search. It is noted that a word may be a sequence of characters. The characters that can be included in a word are configurable. The default characters are (a-z, A-Z, 0-9). Another example of a search pattern includes characters skip-patterns where a number of characters between appearances of selected characters can be specified up to a desired value.

Word boundary is another type of search pattern. In this type of search there is a match of the pattern only if its requested boundaries are not alphanumeric (a-z, A-Z, 0-9). In addition, the search can specify whether it is referring to the left boundary, the right boundary, both or either. There can also be a weighted search. In a weighted search a list of complex patterns can be specified such that at least a predefined number of patterns should appear in order to have a match.

When a signature is matched, a signature basic event may be issued with a parameter indicating the signature type. Examples of basic events that are “signature basic event” (SBE), include one for a request signature and another for a reply signature. These event parameters can be included in the signature id. The SBE is generally available for the correlation engine.

In one example the signature analysis engine support signature updates. Examples of signature updates include the following: (1) add new signature, (2) remove an existing signature; and (3) change an existing signature definition.

Examples of signature definitions include the following: (1) Identifier—unique id; (2) Severity; (3) Type (Security Signature, Server Technology etc.); (4) Request/Reply Signature; (5) List of patterns and for each its following attributes: (a) Pattern string or regex (if type is regex); (b) Pattern name (can be “bogus” identifier); (c) Patterns type (regular/regular expression); (d) Pattern sequential number; (e) the location in which the patterns should be searched in; (f) whether should check pattern for its boundaries; (g) Whether the pattern must appear or must not appear (i.e. pattern or NOT (pattern)); (6) Definition of Complex Patterns; (7) Weighted Search definition; and (8) Extracted data information.

As noted, a Complex Pattern is a sequence of patterns with relations of words skip or characters skip between them. Examples of various skip relations include: (1) Words skip relation—the relation specifying the number of words that should appear between two numbers; (2) “Up To” words skip relation—specifying that the number of words between the appearances of the provided patterns should be up to the provided number; and (3) “Up To” Characters Skip—specifying that the number of characters between the appearances of the provided patterns should be up to the provided matter.

Signature configuration can also include extracted data information. In a typical example the extracted data information includes two items: (1) Regular expression representing the data that can be extracted from the request/reply; and (2). Search Location: the location that the provided regular expression should be matched against. The matching can be done either from the first appearance found in that location or from the beginning of the location as will be set in the HLD.

An example of the operation of the Signature Analysis Engine is described. Upon startup signatures are loaded from a definition file and updated in a signature database. Upon initialization the following may be done: (1) delete signature: a signature that exist in the database and is not included in the current definition file is deleted; (2) add Signature: a signature that does not exist in the database and is included in the current definition file is added; and (3) update signature: a signature that exists both in the signature database and in the current HML definition file is checked to see whether its definition should be changed. The signature analysis engine can then check the request/reply for signature matches. In one example the signature matching itself may be done according to the following phases: (1) Use the search module (patterns manager) for the search of all specified patterns for all signatures; (2) Only if one or more of the patterns is found, process the results; (3) For each signature, add an appropriate event (SBE) in case the signature is matched.

A signature basic event file can include the following: (1) Id: SIGNATURE; (2) Short Description: “Signature was detected at the request*”; (3) Long Description: “The signature % SIGNATURE-NAME % was detected at the request*”; (4) Change Detection flag: off; (5) Policy Element (for update profile rule): NONE; (6) CE Key: %PARAM_VALUE(SIGNATURE, SIGNATURE_ID)%; (7) Security Event Flag: true. It is noted that in a reply signature basic event the word “request” should be replaced with the word “reply”.

Protocol Violation Engine

The collaborative detection module 908 can include a threat detection engine referred to as a protocol violation engine 974. The protocol violation engine 974 protects against attacks that exploit the HTTP and HTTPS protocols to attack Web applications. Web traffic is analyzed by the behavioral analysis engine 970 to ensure that all communication with the application is in compliance with the HTTP and HTTPS protocol definitions as defined by the IETF RFCs. If the behavioral analysis engine 970 determines that there is an anomaly, then the traffic is analyzed by the protocol violation engine 974 to determine the type and severity of the protocol violation. The protocol violation engine 974 provides protection against attacks using the HTTP protocol, for example, denial of service and automated worms.

Session Manipulation Analysis Engine

Another threat-detection engine that can be included in the collaborative detection module 908 is a session manipulation analysis engine 976. Session manipulation attacks are often difficult to detect and can be very dangerous because cyber-criminals, such as hackers, impersonate legitimate users and access functionality and privacy data only intended for a legitimate user. By maintaining all current user session information, it is possible to detect any attacks manipulating or hijacking user sessions, including session hijacking, hidden field manipulations, cookie hijacking, cookie poisoning and cookie tampering. For example, a state tree of all user connections may be maintained, and if a connection associated with one of the currently tracked user's session jumps to another user's session object, a session manipulation event may be triggered.

In an embodiment, session manipulation analysis engine 976 can perform passive session tracking where a predefined list of regular expressions that can identify session IDs in requests and replies is defined. A generation process will choose a subset of these session ID definitions as the ones that are used to identify sessions. These session IDs will be searched for in all requests and replies. The session IDs will be extracted from the request using a combination of the request's objects (such as cookies, parameters, etc), and general regular expressions that are used to extract specific session data. Each set of regular expressions defines which part of the request it runs on, and can be used to extract a value and optionally extract up to two names. In addition, if the regular expression is being searched for in the URL, it can also extract the indexes of an expression that needs to be removed from it. Regular Expression Sets can have one of the following types: (1) Param: Includes two regular expressions. One is searched for in the parameter name, and the other in its value; (2) WholeCookie: includes two regular expressions, one is searched for in the cookie name, and the other in its value (the entire cookie value, without additional parsing); (3) CookieParam: includes three regular expressions, and works on cookies that have been separated correctly into names and values, the first expression is on the cookie's name, the second—on the cookie's parameter name, and the third on the cookie parameter's value. (for example, in the cookie header: “Cookie: mydata=lang=heb| sessionid=900” the cookie's name is “mydata”, the two parameters are “lang” (with the value “heb”) and “sessionid” (with the value 900)); (4) SemiQuery: includes one regular expression that is run on the query that comes after a semicolon (for example, in the URL “/a.asp;$jsessionid$123”, the regular expression will run on the underlined part). (5) NormURL: this regular expression runs on the normalized URL and may return indexes, in which case the part of the URL that is between these indexes is removed—this is done to support sessions that are sent as part of the URL but should not be included in the URL when it is learnt by the ALS; (6) Header: includes two regular expressions, one is searched for in the header name, and the other in its value.

Advanced Correlation Engine

In one embodiment, the ACE 910 includes a first input adapted to receive threat-detection results and to correlate the results to determine if there is a threat pattern. The ACE 910 also includes a second input adapted to receive security policies and to determine an appropriate response if there is a threat pattern. The ACE also includes an output adapted to provide correlation results to an event database 914. The correlation engine examines all of the reference events generated by the detection engines. This can be viewed as combining positive (behavior engine/adaption) and negative security models (signature database) with other specific aspects to web application taken into account (session, protocol). As an example consider a typical SQL Injection, at least one if not two behavioral violations will be detected (invalid characters and length range exceeded) and several signature hits may occur (SQL Injection (Single quote and equals) and SQL Injection (SELECT Statement)). Any one of these events on their own will typically be a false positive, but when correlated together, they may provide a high likelihood of an actual attack.

Another example of the correlation engine is seen when the security system is deployed in monitor only mode and an actual attack is launched against the web application. In this example, the security system will correlate the ExitControl engine events (outbound analysis) with the inbound attacks to determine that they were successful and escalate the severity of the alerting/response.

If the ACE 910 confirms a threat, then the security policy for the application, which is provided by a security policy module 912, is checked to determine the appropriate responsive action. The ACE 910 may also communicate its results to the event database 914 where the ACE results are stored. The event database 914 may also be in communication with a distributive detect prevent architecture (DDPA) module 316.

A security policy, or “Policy”, defines a configuration of the security system's detection and prevention capabilities for a specific site. A policy defines the attacks and information leakage the system will look for while analyzing traffic and what response actions to take should something be detected. A policy may be specific implementation of a general security policy of the organization or enterprise as it relates to a specific web application. A policy can be defined per application, or it can be defined per site. In one embodiment, a policy contains “BreachMarks” and security events which may be presented to a user in a tree structure that contains groups and sub-groups that organize the security events for the user to view. Users will see in the BreachMarks group all available BreachMarks in the system—there is no list per site, a user simple chooses which BreachMarks to enable for this policy.

In one embodiment a Policy can specify the following configurations. For Inbound Events (Attacks): (1) enable/disable; and (2) actions to take for successful attacks, unsuccessful attacks, attempted attacks, and for information leakage. For Outbound Events (Leakage): (1) enable/disable; and (2) action or actions to be performed upon detection of the data leakage. For BreachMarks: (1) whether the data matching a specified BreachMark is to be masked (i.e., obfuscated) in the logs, in events sent to the logs, and/or in reports; and (2) actions to be taken by the security system in response to an event. The security system can take various actions, including: (1) logging events—event information is written to a database that is accessible by the EventViewer that can display event information; (2) Simple Network Management Protocol (“SNMP”) alerts—an SNMP trap can be set that allows the a SNMP message to be generated upon the occurrence of a specified event; (3) reset—a TCP reset can be sent; and (4) block—the attacker can be blocked at the firewall. It is noted that logging an event, or any other desired action, can be the default action for an event that does not have any action identified (e.g. new event, event that was previously disabled).

In one embodiment, a single Policy can be applied to a specific site. In addition, specific policy may be applied to multiple sites. If an “applied” policy is updated, it will remain “applied”, and the updates will take effect in all sites. Users may create custom BreachMarks to define patterns for sensitive information within their organization. In addition a number of pre-defined policies providing configurations tuned to specific vertical markets and levels of acceptable risk can be provided to the user. A “standard policy” can be setup to serve as the default policy. In the event that a user does not “assign” a policy to an application, this default policy can be used. Also, standard policies may be updated and the updates can be distributed to the user. Further, users may create their own custom policies by modifying pre-defined policies in the Policy Manager.

Policies can be imported and exported thereby allowing users to copy policies from one system to another. Typically the security policy module 912 will be responsible for the following tasks: (1) loading/updating a policy from a database, (2) loading/saving policies from/into the database, (3) loading/saving sites-policies associated from/into a configuration file, (4) loading/saving sites-policies association from/into the database, (5) updating relevant components on configuration changes, and (6) performing the configured action in response to a correlated event.

When detecting security events, the policy module 912 receives notification on detected events. Upon receipt of a security event, the policy module 912 checks what responsive action should be taken. When there has been an event the policy module 912 enables signatures that participate in the newly enabled security events. In addition, the policy module 912 may disable signatures that participate only in recently disabled security events. To accomplish this, the policy module 912 determines which signatures are participating in the newly enabled security events and then requests the signatures to add them.

The event database 914 may also be in communication with an event viewer 918, such as a terminal, thereby providing information about events to a network administrator. The event database 914 can also communicate input to a report generating module 920 that generates reports about the various events detected.

Adaption Module

An adaption module 950 monitors Web traffic and continually updates and tunes a security profile module 952 that maintains security profiles of applications. The updated security profiles are communicated to the collaborative detection module 908 so that a current security profile for an application is used to determine if there is a threat to the application. Following is a more in-depth description of aspects and features of the Web application security techniques.

Management Console

A management console can be used to generate displays of information to a network administrator on an event viewer 918 of FIG. 9. For example, management console can generate a web page or other type of graphical user interface that enables an administrator to configure and monitor the operation of the secure WAF 128. The graphical user interface can also include a user interface for interacting with and modifying profile associated with an application as developed and stored in the adaption modules 950 and application profile 952 of FIG. 9.

The management console can also include a policy manager user interface for creating and modifying policies. A policy describes the configuration options for the detection engines as well as what responsive action to take when an event is detected. A policy lists the security events that the Web application security system will monitor and the responsive action to be taken if the event is detected.

The management console can also include an event viewer user interface for viewing the contents of the event log and for viewing real time event analysis.

Returning to FIG. 9, the Web application security system can also provide a full range of reports 920 for network administrators, management, security professionals, and developers about various aspects of the security of a Web application. For example, reports can provide information about the number and types of attacks made against corporate Web applications. In addition, reports can include information with lists of attacks and techniques to assist in preventing them from occurring again. Also, application developers can be provided reports detailing security defects found in their applications with specific recommendations and instructions on how to address them.

Usage Analysis Engine

Still another threat detection engine that can be included in the collaborative detection module 908 is a usage analysis engine 978. The usage analysis engine 978 provides analysis of groups of events looking for patterns that may indicate that a site is being examined by a potential attacker. Targeted Web application attacks often require cyber-criminals to research a site looking for vulnerabilities to exploit. The usage analysis engine 978, over time and user sessions, can provide protection against a targeted attack by uncovering that a site is being researched, before the site is attacked. The usage analysis engine 978 correlates events over a user session to determine if a dangerous pattern of usage is taking place. An example of this analysis is detecting a number of low severity events resulting from a malicious user probing user entry fields with special characters and keywords to see how the application responds. These events may not raise any alarms on their own but when seen together may reveal a pattern of usage that is malicious. Another example of this analysis is detecting brute force login attempts by correlating failed login attempts and determining that threshold has been reached and thus, the user may be maliciously trying to guess passwords or launching a dictionary attack of password guesses at the web application. Another example of this analysis is detecting scans by security tools when an abnormal amount of requests are received in the same session. Yet another example of this analysis is detecting http flood denial of service attacks when an abnormal number of duplicate requests are received in the same session. This analysis can be easily extended to detect distributed denial of service attacks by boot networks correlating multiple individual denial of service attacks.

Exit Control Engine

Yet another threat detection engine that can be included in the collaborative detection module 908 is an exit control engine 980. The exit control engine 980 provides outbound-analysis of an application's communications. While incoming traffic is checked for attacks, outgoing traffic may be analyzed as well. This outgoing analysis provides essential insight into any sensitive information leaving an organization, for example, any identity theft, information leakage, success of any incoming attacks, as well as possible Web site defacements when an application's responses do not match what is expected from the profile. For example, outgoing traffic may be checked to determine if it includes data with patterns that match sensitive data, such as a nine digit number, like a social security number, or data that matches a pattern for credit numbers, drivers license numbers, birth dates, etc. In another example, an application's response to a request can be checked to determine whether or not it matches the profile's variant characteristics.

Web Services Analysis Engine

Another threat detection engine that can be included in the collaborative detection module 908 is a Web services analysis engine 982. The Web services analysis engine 982 provides protection for Web Services that may be vulnerable to many of the same type of attacks as other Web applications. The Web services analysis engine 982 provides protection from attacks against Web services such as XML viruses, parameter tampering, data theft and denial of Web services attacks.

Threats detected by any of the above threat detection engines in the collaborative detection module 908 may be communicated to the advanced correlation engine 910 where they are analyzed in context of other events. This analysis helps to reduce false positives, prioritize successful attacks, and provide indications of security defects detected in the application. In one embodiment, the advanced correlation engine 910 can be based upon a positive security model, where a user's behavior is compared with what is acceptable. In another embodiment, the advanced correlation engine 910 can be based upon a negative security model, where a user's behavior is compared to what is unacceptable. In yet another embodiment, the advanced correlation engine 910 can be based upon both models. For example, the user's behavior can be compared with what is acceptable behavior, a positive model, and if the behavior does not match known acceptable behavior, then the user's behavior is compared with what is known to be unacceptable behavior, a negative model.

The protection system can be implemented using some or all or portions of the systems and methods described in U.S. patent application Ser. Nos. 11/458,965 filed Jul. 20, 2006; 11/532,058, filed Sep. 14, 2006; 11/532,060, filed Sep. 14, 2006; and 10/422,607, filed Apr. 24, 2003, all of which are hereby incorporated by reference. Additionally, the protection system can perform analysis at a macro level across the traffic for all or many of the web servers it is protecting. Which can lead to the detection of wide spread cyber attacks.

Those of skill in the art will appreciate that the various illustrative modules and method steps described in connection with the above described figures and the embodiments disclosed herein can be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules and method steps described in connection with the embodiments disclosed herein can be implemented or performed with a general purpose processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in computer or machine readable media such as RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments.

What is claimed is:

1. A web server protection system for protecting a plurality of remote web servers, the web server protection system comprising:
a secure web application firewall service server coupled to a network and located outside of firewalls associated with each of the web servers, the secure application firewall server comprising
a plurality of secure web application firewalls, wherein each secure web application firewall is configured to
receive a request from a user for content on a web server associated with the secure web application firewall that is in communication with the web server via the network;
analyze the request to identify malicious activity;
perform at least one responsive action if malicious activity is detected; and
forward the request to the web server referenced in the request if malicious activity is not identified.

2. The web server protection system of claim 1 wherein each secure web application firewall is further configured to:
receive a reply from the web server associated with the secure web application firewall that includes the requested content;
analyze the reply to identify malicious activity;
perform at least one responsive action if malicious activity is detected; and
forward the requested content to the user if malicious activity is not identified.

3. The web server protection system of claim 1 wherein the secure web application firewall is configured to receive all requests for content on the web server associated with the secure web application firewall.

4. The web server protection system of claim 3 wherein the firewall of the web server is configured to only allow requests for content that have been forwarded to the web server from the secure web application firewall associated with the web server.

5. The web server protection system of claim 3 wherein a Domain Name System (DNS) record associates a domain name associated with the web site with a network address associated with the secure web application firewall service server.

6. The web server protection system of claim 3 wherein a Domain Name System (DNS) record associates a domain name associated with the web site with a network address associated with the secure web application firewall associated with the web server.

7. The web server protection system of claim 1 wherein the secure web application firewall is further configured to:
forward the request to the web server before analyzing the request to identify malicious activity;
analyze the request to identify malicious activity offline; and
perform at least one responsive action if malicious activity is detected.

8. A method for protecting a plurality of web servers using a secure application firewall server located outside of the firewalls associated with each of the plurality of web servers, the method comprising:
associating a secure web application firewall of a secure web application firewall service server with each of the plurality of web servers, wherein requests for content on the plurality of web servers are routed to the secure web application firewall service server instead of the plurality of web servers;
receiving at the secure web application firewall service server a request for content on a web server of the plurality of web servers;
analyzing the request to identify malicious activity;
performing at least one responsive action if malicious activity is detected; and
forwarding the request to the web server referenced in the request if malicious activity is not identified.

9. The method of claim 8 further comprising:
receiving at the secure web application firewall a reply from the web server associated with the secure web application firewall that includes the requested online content;
analyzing the reply to identify malicious activity;
performing at least one responsive action if malicious activity is detected; and
forward the requested content to the user if malicious activity is not identified.

10. The method of claim 8 wherein all requests to access content on the web server are routed to the secure web application firewall associated with the web server.

11. The method of claim 8 wherein the firewall of the web server is configured to only allow requests for content that have been forwarded to the web server from the secure web application firewall associated with the web server.

12. The method of claim 8 wherein a Domain Name System (DNS) record associates a domain name associated with the web site with a network address associated with the secure web application firewall service server.

13. The method of claim 8 wherein a Domain Name System (DNS) record associates a domain name associated with the web site with a network address associated with the secure web application firewall associated with the web server.

14. The method of claim 8 further comprising:
forwarding the request to the web server before analyzing the request to identify malicious activity;
analyzing the request to identify malicious activity offline; and
perform at least one responsive action if malicious activity is detected.

15. A computer-readable medium comprising processor-executable instructions that, when executed, direct a computer system to perform actions comprising:
associating a secure web application firewall of a secure web application firewall service server with each of the plurality of web servers, wherein requests for online content located on the plurality of web servers are routed to the secure web application firewall service server instead of the plurality of web servers, and wherein the secure web application firewall service server is located outside of firewalls associated with each of the plurality of web servers;
receiving at the secure web application firewall service server a request for content on a web server from the plurality of web servers;
analyzing the request to identify malicious activity;
performing at least one responsive action if malicious activity is detected; and
forwarding the request to the web server referenced in the request if malicious activity is not identified.

16. The computer-readable medium of claim 15, further comprising instructions that, when executed, direct the computer system to perform actions comprising:
receiving a reply from the web server associated with the web application firewall that includes the requested content;
analyzing the reply to identify malicious activity;
performing at least one responsive action if malicious activity is detected; and
forwarding the requested content to the user if malicious activity is not identified.

17. The web server protection system of claim 15 wherein the secure web application firewall is configured to receive all requests for content on the web server.

18. The web server protection system of claim 17 wherein the firewall of the web server is configured to only allow requests for content that have been forwarded to the web server from the secure web application firewall associated with the web server.

19. The method of claim 8 wherein a Domain Name System (DNS) record associates a domain name associated with the web site with a network address associated with the secure web application firewall service server.

20. The method of claim 8 wherein a Domain Name System (DNS) record associates a domain name associated with the web site with a network address associated with the secure web application firewall associated with the web server.

21. The computer-readable medium of claim 15, further comprising instructions that, when executed, direct the computer system to perform actions comprising:
forwarding the request to the web server associated with the web application firewall before analyzing the request to identify malicious activity;
analyzing the request to identify malicious activity offline; and
performing at least one responsive action if malicious activity is detected.
